(19) United States
(12) Patent Application Publication
(10) Pub. No.: US 2003/0093858 A1
(43) Pub. Date: May 22, 2003

(54) WHEELCHAIR TRANSFER ASSIST BOARD

(76) Inventor: Bernard Maizel, Baltimore, MD (US)

Correspondence Address: Finnegan, Henderson, Farabow,, Garrett & Dunner, L.L.P., 1300 I Street, N.W., Washington, DC, 20005-3315, US

(21) Appl. No.: 09/989,198

(22) Filed: Nov. 21, 2001

(51) Int. Cl. A61G 7/08; B62J 1/00; B62H 1/00

(52) U.S. Cl. 5/81.1 R; 280/304.1

(57) ABSTRACT

A generally rectangular wheelchair transfer board is positioned between a wheelchair and a surface for allowing a person to slid across the board between the wheelchair and the surface, or visa versa. The transfer board includes a slot formed along the rear edge of the board and a notch formed along the front edge of the board. The slot is positionable over the wheel of the wheelchair so as to help hold the board in place during use. The notch is placed under the leg of the individual in the wheelchair so as to more easily allow the person to initially position their body onto the transfer board.

### BACKGROUND OF THE INVENTION

1. Field of the Invention

The present invention relates to a wheelchair transfer assist board positionable between a wheelchair and a surface for assisting the transfer of a person to and from the wheelchair and the surface.

2. Description of the Related Art

Many people restricted to a wheelchair require assistance in transferring to and from the wheelchair and a second surface, such as a bed or stationary chair. Because this transfer can often be difficult, wheelchair transfer boards have been developed for bridging the gap between the wheelchair and the second surface. These wheelchair transfer boards assist wheelchair bound people by allowing them to slide to and from the wheelchair and the second surface.

Existing wheelchair transfer boards traditionally come in two types. The first type includes a board having an attachment mechanism for affixing the board to at least one of the wheelchair and the second surface. The attachment mechanism can include prongs or other protrusions for insertion in brackets of the wheelchair, for example, brackets associated with an arm of the wheelchair, or can include clamps or other similar attachment elements. This type of wheelchair transfer board has the benefit of reducing the likelihood of the board shifting or separating from the wheelchair or second surface during a person's movement across the board.

The second type of wheelchair transfer board does not include an attachment mechanism, but is merely positioned between the wheelchair and the second surface without being affixed on either end. While this second type of wheelchair board is easier to use than boards having attachment mechanisms, these type of wheelchair transfer boards have the problem that they may shift or separate from the wheelchair or surface during the movement of a person across the board.

A wheelchair transfer board can also include a element capable of sliding between opposed ends of the board. This type of arrangement allows the person to place the transfer board in position and then position themselves on the sliding element and slide between the wheelchair and the second surface, or visa versa. The sliding element is generally in the shape of a flat seat element, and is arranged so that it slides in a groove or track formed in or on the transfer board. Such a sliding element reduces the effort required in transferring between the wheelchair and the second surface.

### SUMMARY OF THE INVENTION

The advantages and purposes of the invention will be set forth in part in the description which follows, and in part will be obvious from the description, or may be learned by practice of the invention. These advantages and purposes will be realized and attained by way of the elements and combinations particularly pointed out in the appended claims.

To attain the advantages and in accordance with the purpose of the invention, as embodied and broadly described herein, the invention is directed to a transfer board for transferring an individual between a wheelchair and a second surface, the transfer board. The transfer board includes a front edge, a rear edge, a proximal edge and a distal edge; a top surface; a bottom surface substantially parallel to the top surface; and a slot extending into the transfer board from the rear edge for placement over a wheel of a wheelchair to aid in securing the transfer board during use.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a plan view of a transfer board according to the present invention;

FIG. 2 is a profile view of the transfer board of FIG. 1;

FIG. 3 illustrates the transfer board of FIG. 1 positioned between a wheelchair and a bed; and

FIGS. 4 and 5 illustrate the sequential movement of a person utilizing the transfer board to move between a wheelchair and a bed.

### DESCRIPTION OF THE PREFERRED EMBODIMENTS

Reference will now be made in detail to the present preferred embodiments of the invention, an example of which is illustrated in the accompanying drawings. Wherever possible, the same reference numbers will be used throughout the drawings to refer to the same or like parts.

The present invention will be described with reference to the transfer of a person to and from a wheelchair to a bed, but it is within the scope of this invention that the device may be used to assist in transferring a person from a wheelchair or similar device to any surface having a height generally similar to the height of the seat of a wheelchair.

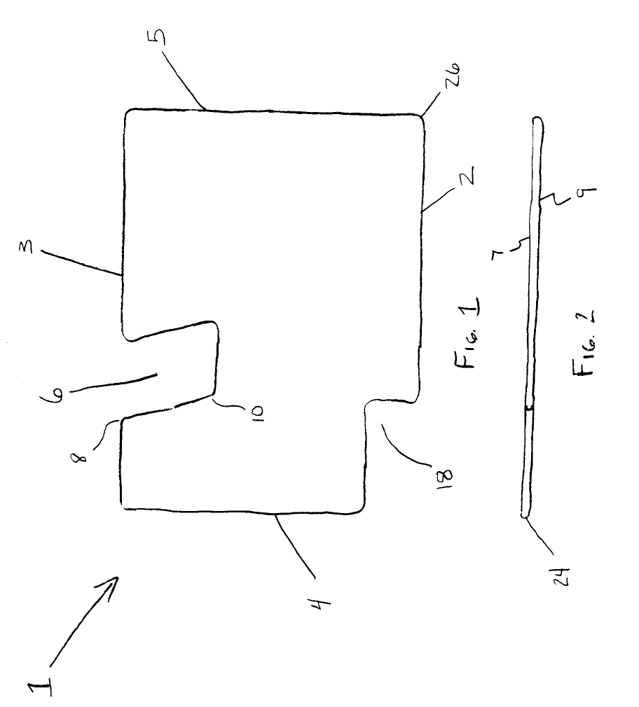

FIG. 1 depicts a transfer board 1 according to one embodiment of the present invention. The transfer board 1 may be generally rectangular in shape and include a front edge 2, rear edge 3, proximal edge 4, distal edge 5, a top surface 7 and a bottom surface 9. Top and bottom surfaces 7, 9 may be formed generally parallel to one another. Transfer board 1 may be formed of any suitable size, for example front and rear edges 2 and 3 of transfer board 1 could have a length of approximately 21 inches, and proximal and distal edges 4 and 5 of transfer board 1 could have a length of approximately 16 inches.

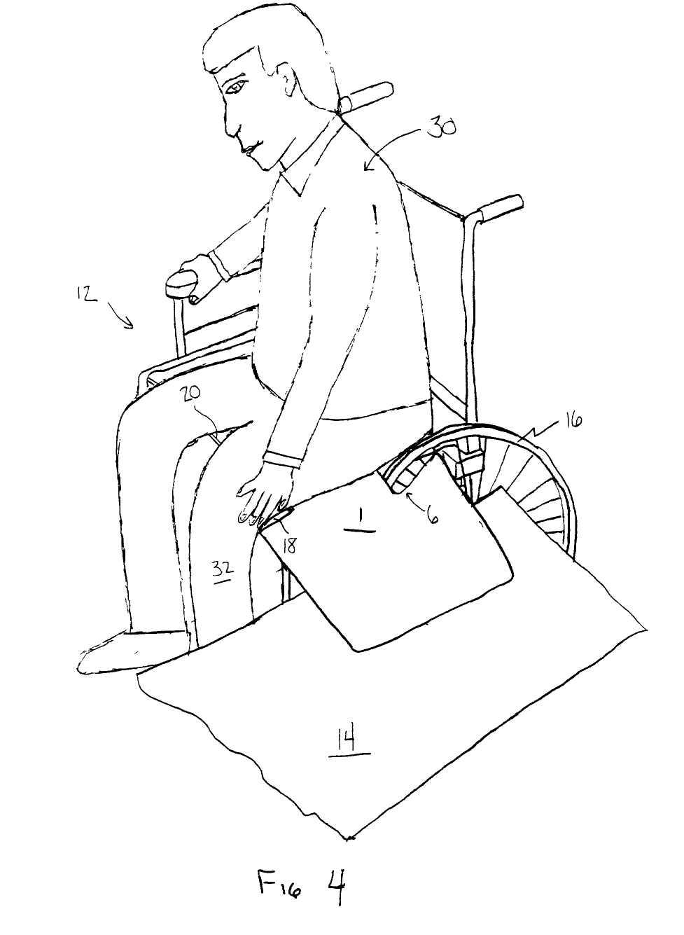

Transfer board 1 may include a generally rectangular slot 6 formed along rear edge 3 and adjacent proximal edge 4. Slot 6 may extend into transfer board 1 in a direction generally toward front edge 2, and may have a width of approximately 4 inches and a depth into transfer board 1 of approximately 5 inches. As illustrated in FIG. 1, slot 6 may also be formed at a slight angle with respect to proximal edge 4. For example, slot 6 may be located approximately 5 inches from proximal edge 4 at a slot rearmost section 8 and approximately 6 inches from proximal edge 4 at a frontmost portion 10, resulting in slot 6 being tilted at an angle of approximately 11 degrees with respect to proximal edge 4. As illustrated in FIG. 3, when transfer board 1 is placed in position between a wheelchair 12 and bed 14, a portion of a wheel 16 of wheelchair 12 closest to bed 14 is positioned within slot 6. This placement of a portion of wheel 16 in slot 6 helps to ensure proper positioning of transfer board 1 between wheelchair 12 and bed 14. Further, the slight angle of slot 6 helps to restrict wheel 16 from unwanted movement out of slot 6.

Transfer board 1 may also include a notch 18 located at the corner of front edge 2 and proximal edge 4. Notch 18 may be formed of any appropriate size, for example, notch 18 may have a length of approximately 6 inches along front edge 2 and a depth of approximately 3 inches along proximal edge 4. As illustrated in FIG. 3, notch 18 allows for a more stable resting of transfer board 1 on wheelchair 12 by reducing undesirable pivoting of transfer board 1. Pivoting is reduced because almost all of proximal edge 4 of transfer board 1 is supported by wheelchair 12. Notch 18 also simplifies the placement of transfer board 1 under the leg of a user because, when properly positioned, transfer board 1 does not extend beyond a frontmost portion 20 of wheelchair seat 22. Further, notch 18 allows the board to have a larger size beyond notch 18 toward distal edge 5 to provide greater support for the person during sliding movement across transfer board 1.

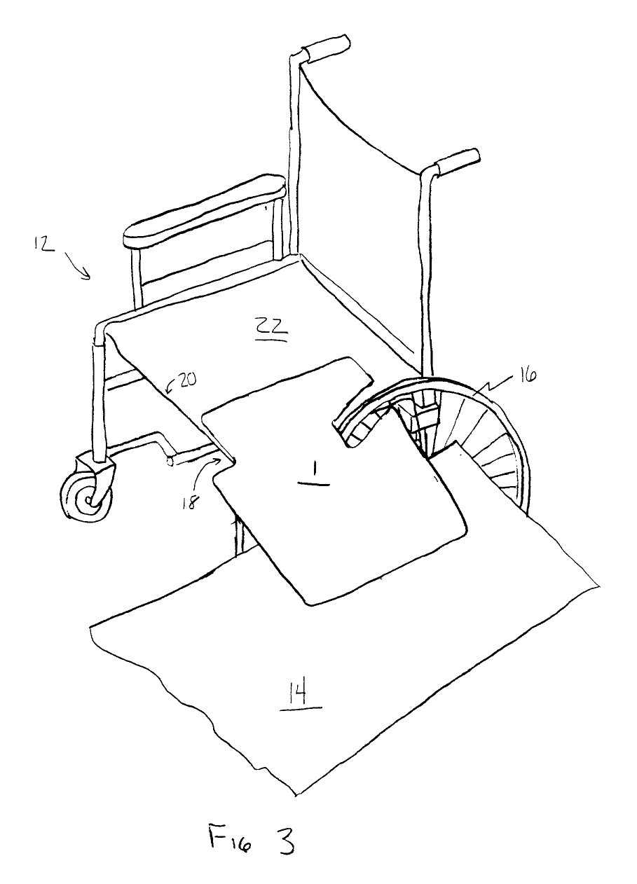

According to one embodiment of the present invention, all of the edges 24 and corners 26 of transfer board 1 may be rounded. FIG. 1 illustrates rounded corners 26, and FIG. 2 illustrates rounded edges 24. Rounded edges 24 and corners 26 may include any appropriate radius, for example 1/2 inch. Rounded edges 24 and corners 26 facilitate the sliding and comfort of a user during movement across transfer board 1.

Transfer board 1 may be formed of any suitable material and thickness capable of supporting the sliding of a user across the board, yet lightweight enough to carry without difficulty. According to one embodiment of the invention, transfer board may be formed of starboard material 1/2 an inch thick. Starboard material is a plastic that is commonly used in the manufacture of kitchen cutting boards. It is within the scope of this invention, however, that transfer board 1 could be formed from wood, metal or other types of plastics.

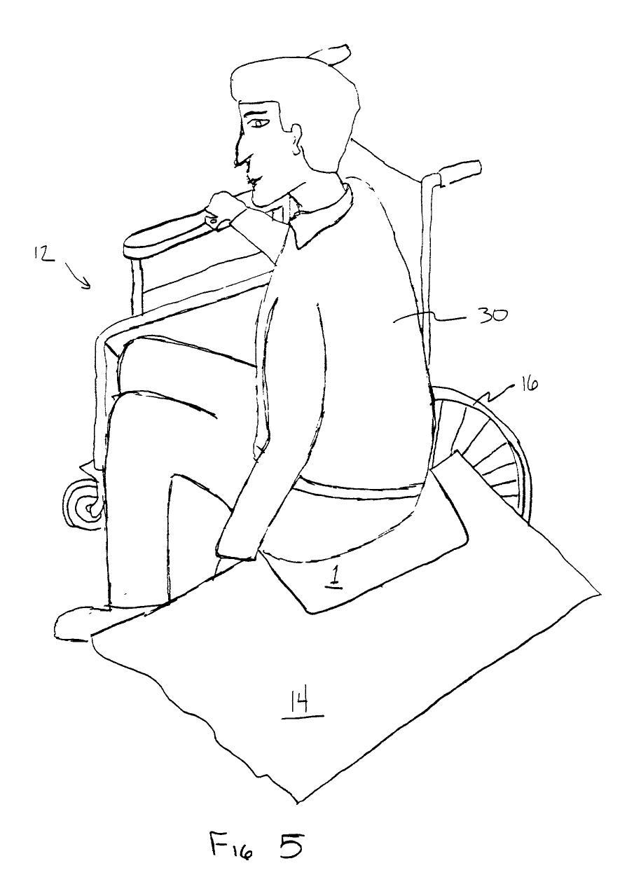

The procedure for using transfer board 1 will now be described. FIG. 4 illustrates a user 30 in wheelchair 12 and transfer board 1 properly positioned. Proper positioning of transfer board 1 includes wheel 16 located within slot 6 and a rearmost portion of notch 18 aligned with frontmost portion 20 of wheelchair seat 22. With transfer board 1 properly positioned, a leg 32 of user 30 is easily moved into position within notch 18. Alternatively, notch 18 allows initial placement of transfer board 1 under the leg of the user. The location of the user's leg in notch 18 provides for an easy initial step in sliding across transfer board 1 and provides further fixing of transfer board 1 in position by body weight forces pushing transfer board 1 against the wheelchair 12 and bed 14. As illustrated in FIG. 5, transfer board 1 then supports user 30 during sliding movement between wheelchair 12 and bed 14.

It is within the scope of the present invention to form transfer board 1 without notch 18, or only with notch 18 and without slot 6. Further, slot 6 may be formed as a notch extending from proximal edge 4, or may be formed perpendicular to rear edge 3 without the tilt angle described in connection with FIG. 1. A transfer board without notch 18 could be formed by reducing the overall width of the board so that proper positioning of the board would place the entire front edge of the board in alignment with the frontmost portion 20 of wheelchair seat 20. Of course, such a transfer board without notch 18 would have to be sufficiently sized to support the weight of a user and provide a stable sliding surface.

Finally, transfer board 1 can be used with any standard type of wheelchair, including those with or without upwardly projecting arms. Further, the dimensions of transfer board 1 set forth above are intended to be exemplary only. Transfer board 1 can be formed of any size as long as the board allows for the general uses described above.

As can be seen from the preceding disclosure, transfer board 1 provides many advantages over the prior art transfer boards and fulfills the need for a lightweight transfer board that can be easily placed in position while the occupant of the wheelchair is still seated, and also is held in place so as not to move out of position while the occupant slides between a wheelchair and another surface.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A transfer board for transferring an individual between a wheelchair and a second surface, the transfer board comprising:
a front edge, a rear edge, a proximal edge and a distal edge;
a top surface;
a bottom surface substantially parallel to the top surface; and
a slot extending into the transfer board from the rear edge for placement over a wheel of a wheelchair to aid in securing the transfer board during use.

2. The transfer board of claim 1, wherein the slot is tilted at an angle with respect to the proximal edge of the transfer board.

3. The transfer board of claim 1, further including a notched corner adjacent the front and proximal edges.

4. The transfer board of claim 1, wherein corners and edges of the transfer board are rounded.

5. The transfer board of claim 1, wherein the transfer board is formed of plastic.
